(19) United States
(12) Patent Application Publication
(10) Pub. No.: US 2015/0343568 A1
(43) Pub. Date: Dec. 3, 2015

(54) METHOD OF LASER ETCHING CLOTH

(71) Applicant: REVOLAZE, LLC, Westlake, OH (US)

(72) Inventors: Darryl J. COSTIN, JR., Avon, OH (US); Kimberly L. RIPLEY, Avon, OH (US); Darryl J. COSTIN, SR., Westlake, OH (US)

(21) Appl. No.: 14/722,755

(22) Filed: May 27, 2015

Related U.S. Application Data
(60) Provisional application No. 62/003,323, filed on May 27, 2014.

(51) Int. Cl. B23K 26/40; D06C 23/02; B23K 26/36

(52) U.S. Cl. CPC B23K 26/4055; B23K 26/365; D06C 23/02

(57) ABSTRACT

The present invention provides systems and methods for imparting designs and/or patterns on fabric by laser etching the fabric at an energy density of about 0.0398 to about 31.85 watts-sec/mm³. The resulting fabric contains designs and/or patterns thereon and has great feel or hand.

This application claims the priority of U.S. Provisional Patent Application No. 62/003,323, filed May 27, 2014, which is incorporated herein by reference.

### FIELD OF THE INVENTION

The present invention relates to etching cloth or fabric and, more particularly, to systems and methods method of laser etching cloth and fabric. In particular, the present invention relates to systems and methods for generating designs and/or patterns on a cloth or fabric surface by laser irradiation.

### BACKGROUND

The basic method used to decorate cloth for automotive and home furnishing applications is conventional printing. Alternate methods, including weaving, embossing, embroidering, and silk screening, have disadvantages including relatively high costs.

Laser etching cloth such as dyed cotton is currently practiced by for clothing applications. Also, laser etching leather is currently practiced for automotive seating applications. Laser etching may be a very economical process to decorate textiles.

However, laser etching cloth for automotive seating applications has not been feasible because the feel or hand of the fabric after lasing has been too harsh for the marketplace. Therefore, a need exists for an improved method of laser etching.

### SUMMARY

An aspect of the present invention is a method for imparting designs and/or patterns on fabric and cloth by laser etching the fabric at a given energy density per unit time. Preferably, the energy density is about 0.0398 to about 31.85 watts-sec/mm³.

Another aspect of the present invention is a system for imparting designs and/or patterns on fabric and cloth by laser etching the fabric. The system includes two or more lasers configured to etch a fabric roll. Each laser is configured to etch a portion of the width of the fabric roll, preferably a pile fabric, at an energy density of about 0.0398 to about 31.85 watts-sec/mm³. The two or more lasers, together, are able to etch the complete width of the fabric roll to generate designs and/or patterns on the fabric surface.

Other aspects of the invention will become more apparent upon reading the following detailed description.

### BRIEF DESCRIPTION OF THE DRAWINGS

The accompanying drawing is incorporated in and constitutes a part of the specification. The drawing, together with the general description given above and the detailed description given below, serve to explain the principles of the invention. The objects and advantages of the invention will become apparent from a study of the following specification when viewed in light of the accompanying drawings, in which like elements are given the same or analogous reference numerals and wherein:

FIG. 1 illustrates a system for processing a fabric roll according to an exemplary embodiment.

### DETAILED DESCRIPTION

The conventional fabric used for automotive seating applications is some type of pile fabric, typically made of polyester or acrylic materials or composites, often with a sponge-type backing The application of a laser to these fabrics tends to melt the fibers and create a surface roughness that results in a poor fabric hand. As used here, “pile” refers fabric having a raised surface or nap, which typically is made of upright loops or strands of yam. Examples of pile fabrics and pile textiles are carpets, corduroy, velvet, plush, and Turkish towels. The word is derived from Latin pilus for “hair”. The surface and the yam in these fabrics are also called “pile”. In particular “pile length” or “pile depth” refer to the length of the yarn strands (half-length of the loops).

However, the control of a specific combination of variables may overcome some, if not all, of the problems associated with using a laser on certain fabrics, e.g., automotive seating fabrics. The four variables that are controlled in the invention are: the energy density per unit time (“EDPUT”) of the laser process; the line density of the graphic; the line thickness throughout the graphic; and the pile characteristic of the fabric.

The EDPUT is defined as (Laser Power/Area of the Laser Spot)*(1/Laser Scan Speed), where the units of EDPUT are watts-sec/mm³, the units of Laser Power are watts, the units of Laser Area of Spot is mm², and the units of Laser Scan speed are mm/second.

The present invention preferably utilizes high speed laser technology with up to a 2,500 watt laser. The higher wattage laser systems allow for faster scan speeds on most materials and thus lower unit costs. For example, the use of a conventional 250 watt laser system may generate 200,000 laser abraded denim jeans per year. The use of TechnoLines 2,500 watt laser system may generate 1.2 million abraded denim jeans per year. However, high wattage lasers may have a difficult time imparting graphic designs and/or patterns on the pile fabrics typically used for automotive cloth because the resulting hand is too rough for commercial applications. Low wattage lasers (e.g., about 1000 watts or lower, preferably about 500 watts or lower, more preferably about 100 to about 5000 watts) are capable of imparting designs and/or patterns on cloth at very high speeds with the appropriate hand if the other variables cited above are controlled. However, the range of EDPUT must be defined in order to provide the desired aesthetic and hand.

Table 1 below shows the range of EDPUT to laser etch cloth with a desired hand provided the other variables are controlled.

TABLE 1
EDPUT Calculations for Laser Etching Cloth

| Scan Speed | Spot Diameter | Area of Spot | Power | EDPUT |
|---|---|---|---|---|
| (mm/sec) | (mm) | (mm²) | (W) | (W-sec/mm³) |
| 1000 | 0.2 | 0.0314 | 100 | 3.184713376 |
| 1000 | 0.4 | 0.1256 | 100 | 0.796178344 |
| 1000 | 0.6 | 0.2826 | 100 | 0.353857042 |
| 20000 | 0.2 | 0.0314 | 100 | 0.159235669 |
| 20000 | 0.4 | 0.1256 | 100 | 0.039808917 |
| 20000 | 0.6 | 0.2826 | 100 | 0.017692852 |
| 1000 | 0.2 | 0.0314 | 1000 | 31.84713376 |
| 1000 | 0.4 | 0.1256 | 1000 | 7.961783439 |
| 1000 | 0.6 | 0.2826 | 1000 | 3.538570418 |
| 20000 | 0.2 | 0.0314 | 1000 | 1.592356688 |
| 20000 | 0.4 | 0.1256 | 1000 | 0.398089172 |
| 20000 | 0.6 | 0.2826 | 1000 | 0.176928521 |

However, a narrower range of EDPUT gives improved results in terms of the hand and additional flexibility in control of the other three variables. Table 2 below shows a narrower range of EDPUT.

TABLE 2
EDPUT Calculations for Laser Etching Cloth

| Scan Speed | Spot Diameter | Area of Spot | Power | EDPUT |
|---|---|---|---|---|
| (mm/sec) | (mm) | (mm²) | (W) | (W-sec/mm³) |
| 2000 | 0.4 | 0.1256 | 100 | 0.398089172 |
| 2000 | 0.6 | 0.2826 | 100 | 0.176928521 |
| 10000 | 0.4 | 0.1256 | 100 | 0.079617834 |
| 10000 | 0.6 | 0.2826 | 100 | 0.035385704 |
| 2000 | 0.4 | 0.1256 | 500 | 1.99044586 |
| 2000 | 0.6 | 0.2826 | 500 | 0.884642604 |
| 10000 | 0.4 | 0.1256 | 500 | 0.398089172 |
| 10000 | 0.6 | 0.2826 | 500 | 0.176928521 |

Laser etching fabric such as denim does not result in a poor hand because the indigo is vaporized to etch the graphic on the material. Therefore, there is not a noticeable feel to the laser etched portion of the denim and thus no impact on the hand of the fabric. Because the feel of the denim material is not drastically affected, it allows a broader range of EDPUT values to be used to achieve aesthetically pleasing laser etched designs and/or patterns. However, too high of an EDPUT on the denim material could cause burning or tearing.

A narrower range of EDPUT may be irradiated onto automotive cloth in order to achieve aesthetically pleasing laser etched designs and/or patterns with a good hand. As used herein, “automotive cloth” means that the cloth is intended to be used in automotive application. The automotive cloth is typically a pile fabric, such as made from polyester or acrylic materials or composites, often with a sponge type backing. If too low of an EDPUT value is applied to an automotive cloth, the laser design and/or pattern will not be visible. If too high of an EDPUT value is applied, the lasered design and/or pattern may look aesthetically pleasing, but it may have a negative impact on the hand and therefore will be unacceptable to consumers. The maximum EDPUT value for automotive cloth is much less than the maximum EDPUT value for denim or leather. However, even if the EDPUT level is within the desired range for use on automotive cloth, other variables must also be controlled to avoid a poor hand. The desired EDPUT value is preferably about 0.0398 to about 31.85 watts-sec/mm³, or about 0.035 to about 1.9 watts-sec/mm³. The EDPUT value is preferably achieved at a scan speed of about 20,000 mm/sec or less, more preferably about 10,000 mm/sec or less, most preferably about 2,000 to about 10,000 mm/sec; and a power of about 1,000 Watts or less, more preferably about 500 Watts or less, most preferably about 100 to about 500 Watts.

Utilization of graphics where the densities of the lines represent less than 50% of the total surface area of the cloth typically produces a very good hand. However, coverage of more than 50% by the lines could still be acceptable, but would require more control of the other variables. Since the hand of the material is so important, the design and/or pattern should have a good balance of open space vs laser etch. Another embodiment is to design the vector graphic to prevent overlap of lines, double hits by the laser, or areas that could be problematic and result in poor hand on the laser etched material.

The thickness of each line throughout the laser etched designs and/or patterns also plays a role in achieving a good hand. The most ideal graphic would only have lines that were one laser line thick. The designs and/or patterns could include different line thicknesses, which would require a more narrow range of EDPUT values. A design and/or pattern with multiple laser line thicknesses would have to run at a lower EDPUT values compared to a design and/or pattern with one laser line thickness throughout. Lines with multiple thicknesses have more coverage on the cloth and therefore could potentially produce a poor hand. The thickness of the laser line will also be dependent on the laser field size. The larger the field size, the larger the laser line thickness. For example, a 20 inch field size produces a sharp laser line with an acceptable hand. Similarly, good results have been achieved with 30 inch laser fields. However, field sizes may range up to 60 inches, but the thickness of the laser line would require a much tighter control of EDPUT values to achieve an acceptable hand. Thus, the field size is preferably less than about 60 inches, and more preferably less than 30 inches.

Although all these techniques improve the hand, control of the fourth variable, the pile characteristic of the cloth, allows for beautiful graphic designs and/or patterns to be lazed on the cloth with superior hand that is rarely achieved with laser etching typical polyester or acrylic or other automotive cloth.

The pile characteristic preferably simulates a brushed or low pile finish, such as suede or nubuck. Previous laser etching trials on various cloths failed to produce a good hand. However, laser etching certain cloths with the brushed or suede pile characteristic produced exceptional hand providing the other three variables were also controlled within desired ranges. Different polyester fabrics with this type of finish produced unexpected but excellent hand when laser etching graphic designs and/or patterns with single laser lines and with relatively low line density (preferably less than 50% of the total area of the cloth) using EDPUT value ranges between 0.0398 to 31.85 watts-sec/mm³, or preferred ranges between 0.035 to 1.9 watts-sec/mm³.

Another benefit of this invention is the ability to manufacture laser etched cloth in a low cost, more economical way. Instead of laser etching a cloth in piece goods or one-at-a-time fashion, with the present invention one may etch cloth on standard 60 inch roll goods in a continuous “etch-on-the-fly” or linear scribing manner. However, one of the barriers associated with laser etching the cloth in this manner is that the resolution of the graphic is inversely proportional to the laser field size. Our earlier work experimented with one laser with a 60 inch field so that it could scan back and forth using 60 inch textile roll goods, e.g., denim roll goods were unwound, passed underneath a laser, and then were rewound. This concept generated a low cost process to add designs and/or patterns to textiles or denim.

However, for automotive cloth, particularly pile fabric, a requirement for a finer resolution graphic design and/or pattern is specified. In order to achieve the required specification in a low cost process, more than two lasers can be used as long as the field sizes of the lasers add up to approximately the field size required for the fabric surface. For example, two lasers with 30 inch field size each may be used to lase a roll of fabric having a width of 60 inches, with each laser continuously lazing one-half the width of the roll of cloth. Alternately, three lasers with 20 inch field each could be utilized, where each laser continuously lases one-third of the width of the roll of cloth. The graphic resolution of the latter case would be even finer or more precise. Other combinations are also appropriate as long as the sum of the field sizes of the lasers add up to approximately the width of fabric.

One problem that may arise from using more than one laser to collectively lase a width of the fabric is that the resulting design and/or pattern may include gaps at the locations where the two or more laser scans meet or abut. The graphic design and/or pattern of the present invention preferably is adjusted on each laser to eliminate the lines of demarcation that occur when multiple laser portions meet. For example, if a denim roll is 60 inches wide, one laser can etch the first 30 inches and another laser can etch the second 30 inches. To operate in a linear process, a graphic may be divided into individual parts and each laser etches one part until the entire graphic is finished. If the denim is lased vertically along the width, each line from each laser will meet in the middle of the denim roll. When this occurs, there is typically a gap of unlazed fabric where the two lasers meet. That problem can be eliminated by staggering the laser lines from part to part and in the locations where the laser scan lines meet. The laser fields are in the invention allowed to overlap to laze overlapping designs and/or patterns. According to an exemplary embodiment, to service a total field size of 60 inches, two lasers, each having a field slightly larger than 30 inches (e.g. 35 inches), may be used to allow for an overlap (e.g. 5 inches) from each laser. As such, the field of each laser should be calculated so that it is greater than the total field size to allow for overlap of the design and/or pattern of each laser. Preferably, the overlap should be about 1% to about 50% of the total desired field size, more preferably about 2% to about 10%.

In another embodiment of the present invention, the fabric material may be laser cut to a specific pattern before or after the material is laser etched. This process may occur in piece goods, one-at-a-time, or on a continuous conveyor, or it could occur on the linear roll good in a continuous “etch-on-the-fly” manner. The same laser could lase the material, then cut a specific pattern or one laser could laser etch the material and another laser next to it could cut out the pattern. Regardless of how many lasers are involved or which step occurs first, all lasing may occur in the same process.

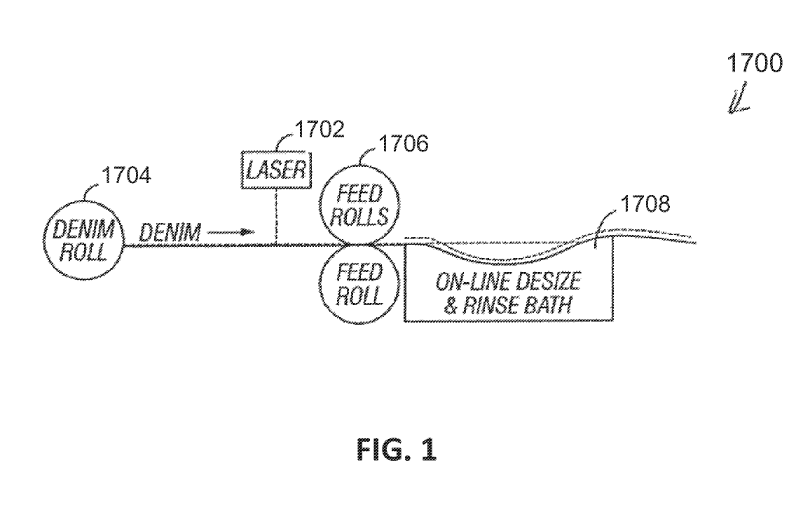

The above-described methods and systems can be used in various laser processing systems. For example, as illustrated in FIG. 1, system 1700 includes a laser 1702, preferably having 2,500 watts power used to process a surface of the fabric based and generate designs and/or patterns is mounted over a table and one or more lasers scribes the designs and/or patterns onto the surface of the fabric. When a plurality of lasers is implemented, the lasers collectively translate across the width of the fabric roll and/or along the machine direction (e.g., in the direction of the length of the denim). Specifically, the fabric can be fed onto the table from a denim roll 1704 using feed rolls 1706. In certain embodiments, no further processing is necessary. In other embodiments, the lazed fabric may be washed and/or rinsed in a bath 1708 and/or laser cut (as described above).

As those skilled in the art will appreciate, laser system 1700 has one or more movable mirrors that direct the laser beam across the surface being lazed. The mirrors typically move the beam in the “X” and “Y” directions in order to scan across the surface. The system 1700 will typically include one or more lenses in order to focus the beam so the beam has a diameter appropriate for etching the desired graphic to the resolution required. An exemplary laser system 1700 is shown in U.S. Pat. No. 8,460,566, the assignee of which is the assignee of this application, the entire disclosure of which is incorporated herein by reference. That patent also illustrates and discloses the use two lasers, as contemplated herein, and interleaving the laser lines in order to eliminate the “joint” where two lasers lines abut.

Whether a continuous two-laser or three-laser roll goods laser etching process is utilized or one laser with a conventional one or several-at-a-time piece goods process is utilized, the keys to providing a satisfactory hand is to control all four variables, namely, the EDPUT, graphic line density, line thickness (or field size) and pile characteristic of the cloth.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

What is claimed is:

1. A method of generating a design and/or pattern on a fabric, comprising the step of:
providing a fabric to be laser etched;
providing a laser proximate the fabric; and
laser etching the fabric at an energy density per unit time (EDPUT) of between 0.0398 to 31.85 watts-sec/mm³ or 0.035 to 1.9 watts-sec/mm³.

2. The method of claim 1, wherein the laser power is less than 1,000 Watts and the laser scan speeds is 20,000 mm/second or less.

3. The method of claim 1, wherein the fabric has a brushed or pile finish.

4. The method of claim 1 wherein the fabric is an interior fabric for automotive seating.

5. The method of claim 1, wherein the fabric has a suede or nubuck finish.

6. The method of claim 1, wherein the fabric is a polyester or acrylic fabric.

7. The method of claim 1, wherein the fabric comprises a sponge backing.

8. The method of claim 1, wherein a density of the laser lines is less than 50% of the total area of the fabric.

9. The method of claim 1, wherein the laser lines are at least one laser line thick with a laser field size of about 35 inches or less.

10. The method of claim 1, wherein at least two lasers are disposed proximate the fabric, each laser having a field size of about 35 inches or less and etching a portion of the width of the fabric with each of the lasers.

11. The method of claim 10, wherein the at least two lasers provides regions of overlapping design and/or pattern between the lasers.

12. The method of claim 1, further comprising a step of laser cutting a seat pattern on a fabric.

13. The method of claim 11, wherein the cutting step is after the etching step.

14. The method of claim 1, wherein the fabric has a brushed or pile finish.

15. The method of claim 1 wherein the fabric is an interior fabric for automotive seating.

16. The method of claim 1, wherein the fabric is a polyester or acrylic fabric.

17. A system for generating a design and/or pattern on a fabric comprising at least two lasers, wherein each laser has a field size of about 35 inch or less and is configured to etch a portion of a width of the fabric at an energy density per unit time (EDPUT) between 0.0398 to 31.85 watts-sec/mm³ or 0.035 to 1.9 watts-sec/mm³.

18. The system of claim 17, comprising two lasers, each laser having a field size of about 35 inches and is configured to etch about 30 inches of the width of the fabric and to provide an of overlap of about 5 inches between the lasers.

19. The system of claim 17, wherein the laser power is less than 1,000 Watts and the laser scan speeds is 20,000 mm/second or less.

20. The system of claim 17, further comprising a cutting laser configured to cut a seat pattern on the fabric.
